(19) United States
(12) Patent Application Publication
(10) Pub. No.: US 2015/0328920 A1
(43) Pub. Date: Nov. 19, 2015

(54) METHOD OF FORMING A MULTILAYER CUT OUT STRUCTURE

(71) Applicants: Monika Brandrup-Thomas, Guilford, CT (US); Yevgeniya Yeretskaya, New Haven, CT (US)

(72) Inventors: Monika Brandrup-Thomas, Guilford, CT (US); Yevgeniya Yeretskaya, New Haven, CT (US)

(73) Assignee: Up With Paper, LLC, Mason, OH (US)

(21) Appl. No.: 14/277,486

(22) Filed: May 14, 2014

(51) Int. Cl. B44F 3/00; B44C 3/08; B31D 1/00

(52) U.S. Cl. CPC B44F 3/00; B31D 1/00; B44C 3/082

(57) ABSTRACT

A generally planar ornamental structure is formed by dividing a large common panel into subpanels at fold lines, and cutting individual lines through each of the subpanels. The subpanels are then folded on each other in an accordion-like structure to form overlapping subpanels, providing a desired design configuration. This can be used to form, for example, an ornamental box lid, a greeting card or a portion of a book, such as a child's book.

### BACKGROUND OF THE INVENTION

Very unique, artistic designs can be formed by layering generally planar panels, such as paper stock, on top of each other. A unique design can be formed by cutting out portions of each panel and then stacking one on top of the other, so that the cutout portions combine to form a multilayered cutout structure with an aesthetically appealing design.

These multilayered designs can be employed in a variety of different articles, such as children's books, greeting cards, merchandising items such as displays, boxes and the like. Unfortunately, these types of designs tend to be relatively expensive to produce, particularly in limited quantities. Separate individual panels must be cut out and then subsequently aligned and combined together to provide the desired end product. The time required to do this increases the cost significantly.

### SUMMARY OF THE INVENTION

The present invention is based on the discovery that a multilayer planar cutout structure can be formed by first cutting out two or more separate designs on a single common panel and forming one or more fold lines between the different designs to form smaller subpanels. The multilayer cutout structure is then formed by simply folding the subpanels onto each other at the fold lines. The cutout portions can be formed with a laser cutter or water jet cutter, or can be die cut. The fold lines can be established either before or after cutting.

The fold lines are formed at precise locations to properly align the different cut outs as the subpanels are folded onto each other. Although not required, fold lines may define equally-sized, overlapping panels.

Further, three or more panels can be formed from a single common panel with two or more fold lines and two or more different cutout patterns. The multiple cutout patterns can then be aligned together by folding the different subpanels in an accordion-type manner. This method allows for three or more overlapping designs.

The method of the present invention ensures that the different cutout designs are very precisely aligned, improving product quality and reducing costs.

Further, the top surface and the bottom surface of the common panel can be different colors to provide different effects, when the subpanels are folded on each other. The common panel may be printed with different designs, for example, with different colors, so that the first subpanel will be a first color, the second subpanel a second color and the third subpanel a third color.

The objects and advantages of the present invention will be further appreciated in light of the following detailed description and drawings, in which:

### BRIEF DESCRIPTION OF THE DRAWINGS

FIG. 1 is a perspective view of the present invention;

FIG. 2 is an overhead plan view of the flat common panel;

FIG. 3 is an overhead plan view of the present invention;

FIG. 4 is an exploded view of the embodiment shown in FIG. 1;

FIG. 5 is a cross-sectional view taken at lines 4-4 of FIG. 1;

FIG. 6 is a plan view of an alternate design of the present invention;

FIG. 7 is a plan view of a second alternate design of the present invention;

FIG. 8 is a plan view of a third alternate embodiment of the present invention; and

FIG. 9 is an isometric view of a fourth alternate embodiment.

### DETAILED DESCRIPTION OF THE INVENTION

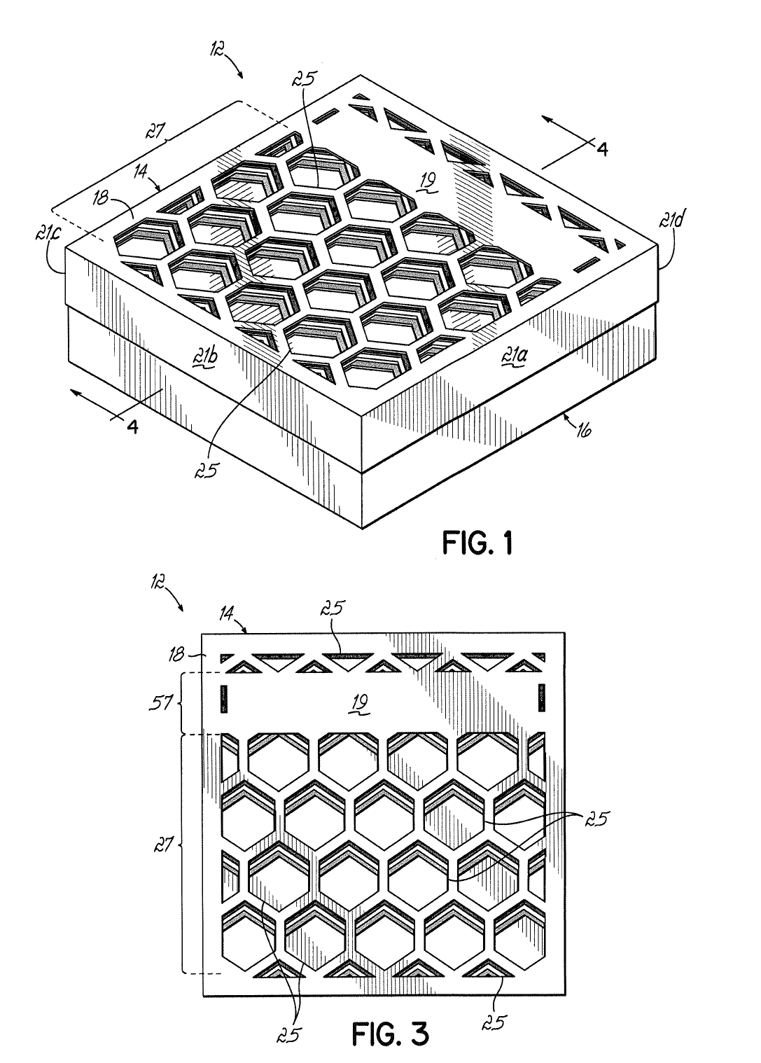

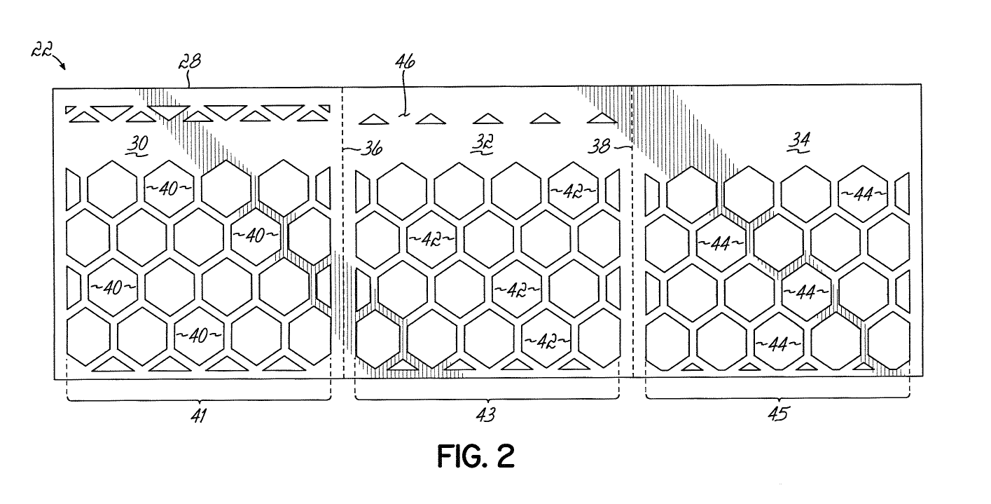

FIGS. 1-5 show a box having a lid incorporating the present invention. However, the present invention can be further utilized in a wide variety of different applications and certainly is not limited to formation of a box lid. This is merely an exemplary embodiment and the present invention can be further utilized in greeting cards, books and, in fact, any visual display.

As shown in FIG. 1, a box 12 includes a lid or cover 14 and a base 16. Box lid 14 includes an outer member 18, an inner member or slip 20 and a generally planar insert 22. The outer member 18 of lid 14 includes top panel 19 and four side walls 21a, 21b, 21c, 21d. Likewise, the inner member 20 of lid 14 includes a top panel 23 and four side walls 24a-d. As shown, the top panel 19 of the outer member 18 of lid 14 includes a plurality of cutout areas 25, leaving a two-dimensional design, in this case, showing a plurality of hexagons 27.

The generally planar insert 22 is formed from a single common panel 28, which has a first subpanel 30, a second subpanel 32 and a third subpanel 34, separated from each other by a first fold line 36 and a second fold line 38. In this embodiment, the insert has three separate subpanels, however, common panel 28 could have only two subpanels separated by one fold line, or could have, for example, four subpanels separated by three fold lines, or even more. Further, the common panel and the subpanels are shown as rectangular. But they can be different shapes, such as circular or hexagonal, depending on the desired product. The fold lines are generally lines of weakness which facilitate folding. Usually they are simply pressed into the common panel.

First panel 30 includes first cutout areas 40, leaving a three-dimensional design 41 which, in this case, again is a series of hexagons. Likewise, second panel 32 includes second panel cutout areas 42, which leave a design 43, again hexagonal shapes. And finally, third panel 34 includes third panel cutout 44, leaving design 45. The design 43 in second panel 32 is reverse cut relative to design 41 and 45 in the first and third panels because of the manner it is folded, as described below.

The common panel 28 can be formed from a variety of different materials, which can be cut through to form an ornamental design. In one embodiment, this common panel 28 can be formed from paperboard stock. The thickness is a matter of design choice. It can be simply paper or thicker cardboard stock, depending upon the desired end use and required durability. Further, the product can be formed from plastic materials and the like, assuming they have sufficient rigidity, to provide the desired end product and can be formed with fold lines. Common panel 28 includes a first surface 46, referred to as a “top surface”, and a second surface (not shown), referred to as a “bottom surface”. The top surface 46 and bottom surface may have different colors to provide different appearances after folding the insert together. Further, the individual subpanels can have different colors on either the top surface of the bottom surface, or they can be illustrated, depending, again, upon the desired look of the end product.

To form the insert 22, the designs 41, 43 and 45 of the subpanels 30, 32 and 34, are cut out through the top surface 46, for example, using a laser cutter. The fold lines 36 and 38 can be formed into the cardboard stock, either before or after forming the cutouts 40, 42, 44.

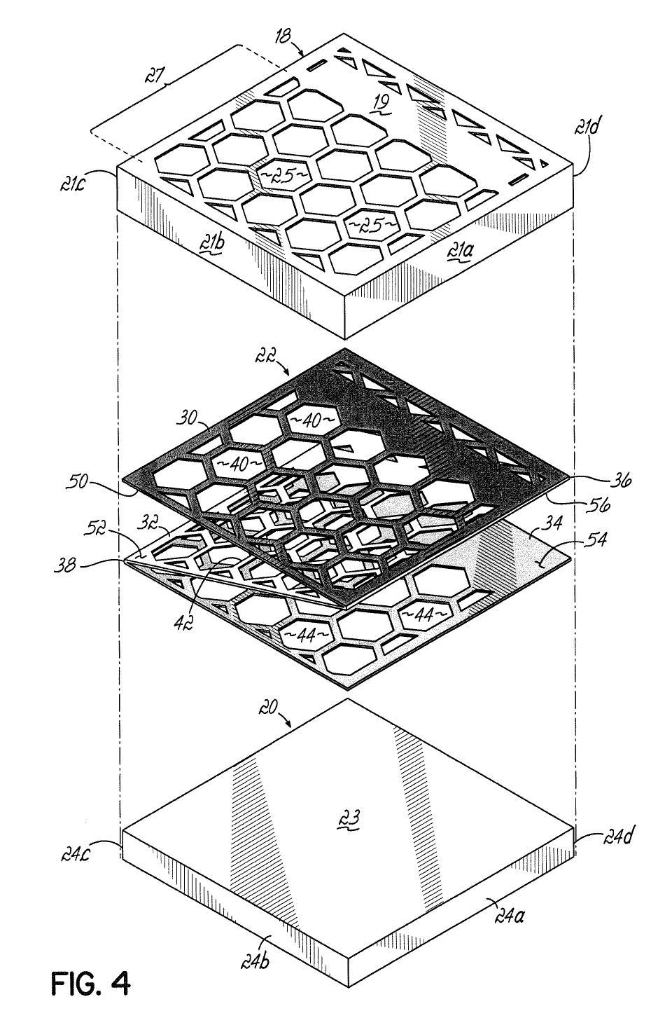

As shown in FIG. 4, to form the multilayer overlapped panel 22, the subpanels 30, 32 and 34, with cutouts 41, 43 and 45 are folded relative to each other at fold lines 36 and 38. The bottom surface 50 of panel 30 is folded at fold line 36 onto the bottom surface 52 of panel 32. The top surface 54 of panel 34 is folded at fold line 38 onto the top surface 56 of panel 32. This aligns cutout designs 41, 43, and 45 over each other. Once folded together, multilayer overlapped panel 22 is placed between the outer member 18 and inner member or slip 20 of the lid 14 on panel 23. Panel 23 of inner member 20 is shown as a solid panel. However, it can also have a cutout or printed ornamental design which will show through any aligned cutout areas of panels 30, 32 and 34.

Outer member 18 is then placed over this assembly, with the panel 19 of the outer member 18 resting directly on the first panel 30 of overlapped panel 22.

Outer member 18 of lid 14 fits over inner member 20, with the sidewalls 21a-d of the outer member 18 alongside the sidewalls 24a-d of the inner member 20. The respective sidewalls 21a-d and 24a-d are adhered together, trapping the overlapped folded multilayered panel 22 on panel 23 of inner member 20.

The design of the end product is more particularly shown in FIGS. 1 and 3. As can be seen, the hexagonal design 27 in panel 19 of the outer member 18 of the lid aligns with a slight offset with the design portions 41, 43, 45 of the subpanels 30, 32 and 34 providing a slightly staggered three-dimensional effect. The panel 19 further includes a portion 57 that allows for indicia or other packaging. However, this is merely exemplary and any design can be incorporated into the respective surfaces.

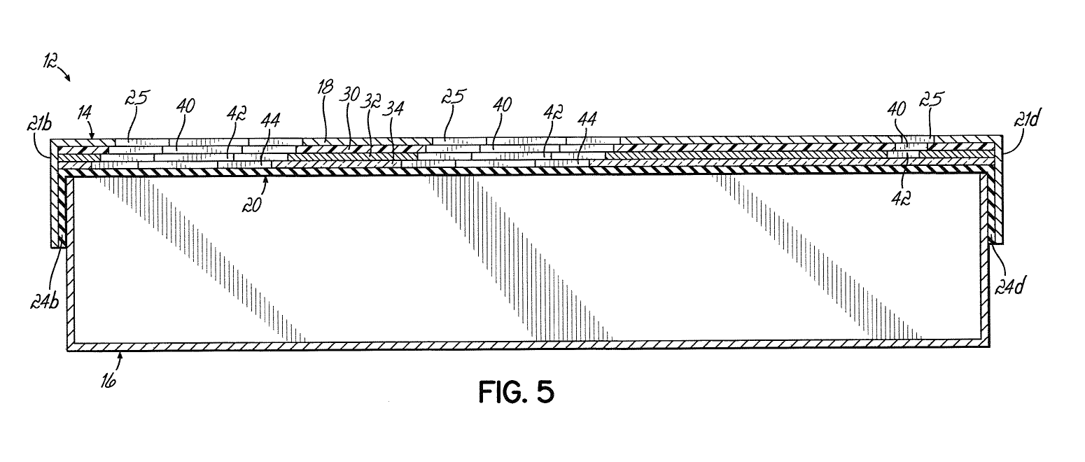

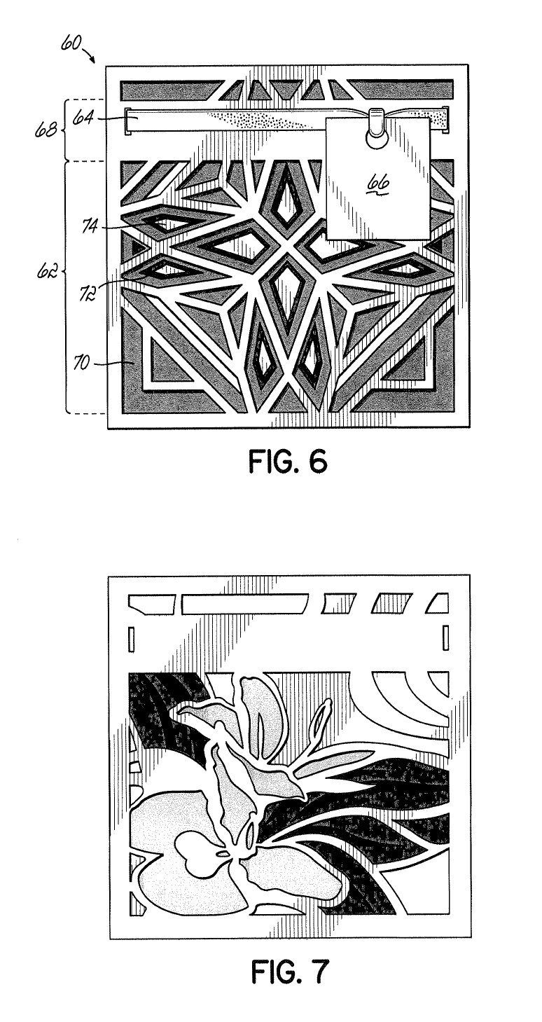

FIGS. 6, 7 and 8 show alternate embodiments of the overlapped multi panel of the present invention. As shown in FIG. 5, the lid 60 includes a top cutout design 62. A ribbon 64 and tag 66 are attached to the lid at a display area 68. Beneath design 62 cut through the top layer of lid 60 are design areas 68, 70, 72, resting on surface 74.

As with the embodiment shown in FIGS. 1-5, the designs 70, 72 and 74 are cut through a common panel which is folded in the same manner shown in FIG. 3. In the embodiment shown in FIG. 6, the design is different.

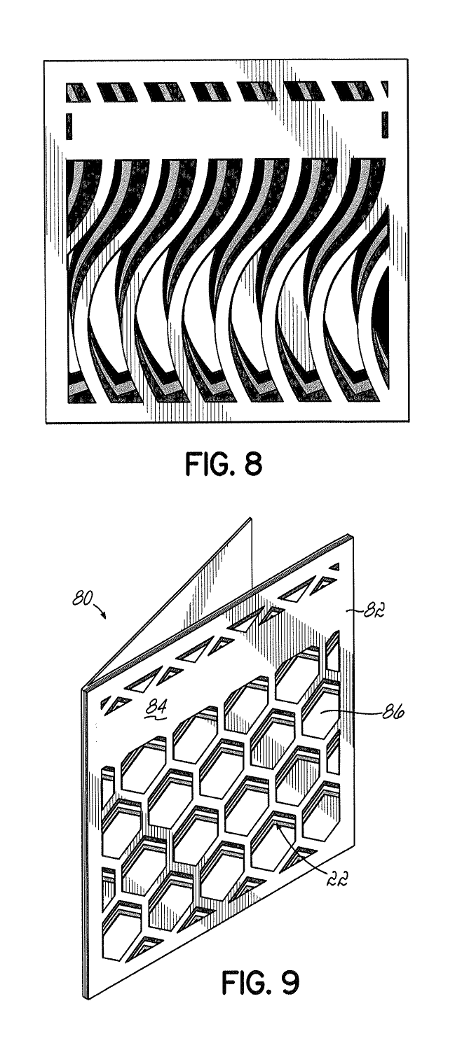

Likewise, FIGS. 7 and 8 show the same structure depicted in FIGS. 1-4 but with different designs.

The multilayered panel 22 can be used as part of a greeting card 80, as shown in FIG. 9, where panel 22 is held by a cutout panel 84 (similar to top panel 19 of lid 14) with a solid backing panel 86 on the cover 82 of the greeting card 80. Regardless of the nature of the final product, the method of making overlapping panels 22 with cutouts that form intricate designs reduces costs and improves the end product by insuring that the subpanels are precisely aligned and can be assembled quickly. The end product can be utilized in a wide variety of different applications.

This has been a description of the present invention. The invention itself should only be defined by the appended claims wherein we claim:

What is claimed is:

1. A method of forming multilayer overlapping cutout panel structure comprising forming one or more fold lines onto a common panel, thereby dividing said common panel into subpanels;
forming cutouts through said two or more of said subpanels; and
folding said subpanels upon each other, so that planar surfaces of said subpanels rest on each other with the cutouts of said subpanels aligned to form a desired ornamental design.

2. The method claimed in claim 1 wherein said common panel is divided into at least three subpanels by at least two fold lines, and wherein said cutouts are formed in each of said at least three subpanels.

3. The method claimed in claim 1 wherein said common panel has a top surface and a bottom surface, and said top surface has a first color and said bottom surface has a second color, different from said first color.

4. The method claimed in claim 1 wherein each said top and bottom surface comprise multiple colors.

5. The method claimed in claim 1 wherein at least one of said top and bottom surfaces are illustrated.

6. The method claimed in 1 further comprising trapping said cutout structure between a top layer and a bottom layer, wherein said bottom layer is a solid panel and said top layer is a panel having a cutout portion.

7. The method claimed in claim 6 wherein said cutouts are formed with a laser cutter.

8. The method claimed in claim 1 wherein said cutouts are formed with a water jet cutter.

9. The method claimed in claim 1 wherein said cutouts are die cut.

10. The method claimed in claim 6 wherein said method forms a box lid.

11. The method claimed in claim 6 wherein said method forms a greeting card.

12. A generally planar ornamental structure comprising:
a single common panel separated into three or more subpanels by two or more fold lines;
at least two of said subpanels having a cutout design;
wherein said subpanels are folded onto each other so that said cutout designs overlap; and
said subpanels are aligned with each other, providing a generally planar structure.

13. The ornamental structure claimed in claim 12, wherein each of said subpanels is generally rectangular and said common panel is generally rectangular.

14. The ornamental structure claimed in claim 12 wherein said panels are non-rectangular.
